(19) United States
(12) Patent Application Publication
(10) Pub. No.: US 2009/0241112 A1
(43) Pub. Date: Sep. 24, 2009

(54) RECORDING MEDIUM RECORDING VIRTUAL MACHINE CONTROL PROGRAM AND VIRTUAL MACHINE SYSTEM

(75) Inventor: Kenichirou SHIMOGAWA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/406,516

(22) Filed: Mar. 18, 2009

(30) Foreign Application Priority Data
Mar. 19, 2008 (JP) 2008-070545

(51) Int. Cl. G06F 9/455

(52) U.S. Cl. 718/1

(57) ABSTRACT

A computer-readable medium on which is recorded a program for causing an information processing device to execute, setting each of the plurality of physical CPUs as a physical CPU for first process or a physical CPU for second process; setting a first CPU time and a second CPU time to different values; and when the control right of a physical CPU for the first process is assigned to any one of the plurality of virtual machines, setting the first CPU time for the virtual machine and assigning the control right to the virtual machine, and, when the control right of a physical CPU for the second process is assigned to any one of the plurality of virtual machines, setting the second CPU time for the virtual machine and assigning the control right to the virtual machine.

### CROSS-REFERENCE TO RELATED APPLICATION

This application is based upon and claims the benefit of priority of the prior Japanese Patent Application No. 2008-70545, filed on Mar. 19, 2008 the entire contents of which are incorporated herein by reference.

### FIELD

The present invention relates to a recording medium recording a virtual machine control program causing a virtual machine for performing a first process and a virtual machine for performing a second process to operate in different physical CPUs and a virtual machine system.

### BACKGROUND

In virtual machine systems, a virtual machine monitor individually assigns (dispatches) control rights of a plurality of physical CPUs to a plurality of OSs (operating systems, that is, virtual machines), and the control rights of these physical CPUs are individually transferred from the OSs back to the virtual machine monitor.

According to Japanese Laid-open Patent Publication No. 2006-059052, in a virtual machine system, while adopting a time slice system as one of the scheduling method of the having a means to change the performance of the command processor of the physical computer processed for every virtual computer, and a means to set up the hour of use of a command processor is proposed.

According to Japanese Laid-open Patent Publication No. 2006-127462, while two or more logic processors use a physical processor by time-sharing, the system which enables processing which set up correspondence of the optimal logic processor and a physical processor by the load of hardware or the mode of a program is proposed.

In virtual machine systems, a plurality of guest OSs (virtual machines) generally operate and execute different types of jobs (e.g., workloads, that is, programs for performing work). Representative types of jobs include a CPU bound job and an I/O bound job. A CPU bound job is a program for performing a computation such as a scientific computation while intensively using a CPU (hereinafter referred to as a “physical CPU”). The larger the amount of CPU time allotted to a CPU bound job, the faster the response of the CPU bound job. An I/O bound job is a program for frequently performing input/output (I/O) process via a disk device or a network in a database system. The shorter the time it takes to complete the I/O process, the faster the response of the I/O bound job.

In virtual machine systems, a plurality of guest OSs perform the CPU bound job and the I/O bound job. As a method of effectively transferring a CPU control right from each of these guest OSs back to a virtual machine monitor, a method of performing the setting of a dispatching timer and idle detection in combination can be considered.

At the time of dispatching, the value of a dispatching timer is set to a specific value. As a result, even if a guest OS continues to use a CPU, the control right of the CPU is transferred from the guest OS back to a virtual machine monitor without fail after a specific period of time has elapsed. If a CPU bound job is executed in a guest OS, the control right of a CPU is usually transferred from the guest OS back to a virtual machine monitor after the specific period of time has elapsed. That is, if the control right of the CPU is transferred from the guest OS to the virtual machine monitor as described previously, it can be determined that the guest OS is a guest OS for performing a CPU bound job (hereinafter referred to as a CPU bound guest OS).

In the idle detection, the idle state of a guest OS is detected. After the idle state of the guest OS has been detected, it is impractical to wait until a specific period of time set for a dispatching timer has elapsed. Accordingly, a virtual machine monitor retakes the control right of a CPU from the guest OS being idle and gives the control right of the CPU to another guest OS. If an I/O bound job is executed in a guest OS, it is necessary to wait for the completion of I/O process. Accordingly, after the idle state of the guest OS has been detected, the control right of a CPU is usually transferred from the guest OS back to a virtual machine monitor. If the control right of the CPU is transferred from the guest OS back to the virtual machine monitor as described previously, it can be considered that the guest OS is a guest OS for performing an I/O bound job (hereinafter referred to as an I/O bound guest OS).

However, according to studies by the inventor of the present invention, the following problems have been found in the above-described method of performing the setting of a dispatching timer and idle detection in combination.

That is, as illustrated in FIG. 7, an I/O bound guest OS #101 executes an I/O interrupt at a time t101. This I/O interrupt is completed at a time t102. However, at that time, since CPU bound guest OSs #102 and #103 are operating, a virtual machine monitor sequentially assigns the control right of a CPU to the CPU bound guest OSs #102 and #103. Accordingly, the I/O bound guest OS #101 has to wait to perform an I/O completion interrupt until the control right of the CPU is assigned at a time t103.

Thus, the I/O bound guest OS #101 is significantly affected by the CPU bound guest OSs #102 and #103. That is, the I/O response of the I/O bound guest OS #101 becomes slow. As the number of CPU bound guest OSs increases, the I/O bound guest OS #101 is more significantly affected by these CPU bound guest OSs.

For example, as a method of overcoming the above-described difficulty, a method of setting the value of a dispatching timer to a smaller value and shortening the period of time during which each guest OS retains the control right of a CPU can be considered. In this case, the control right of the CPU can be assigned to an I/O bound guest OS more quickly. However, the switching of the control right of the CPU between guest OSs occurs frequently, and the number of runs of the virtual machine monitor is increased. This increases overhead.

As another method of overcoming the above-described difficulty, a method of preferentially assigning the control right of a CPU to an I/O bound guest OS waiting to perform an I/O completion interrupt can be considered. In this case, a guest OS waiting to perform an I/O completion interrupt is detected and a notification that the guest OS is waiting to perform an I/O completion interrupt is preferentially transmitted to a virtual machine monitor. However, if the number of I/O bound guest OSs is large and the number of CPU bound guest OSs is small, it is difficult to assign the control right of a CPU to these CPU bound guest OSs. Furthermore, a virtual machine monitor needs to include units for detecting a guest OS waiting to perform an I/O completion interrupt. This leads to an increase in overhead.

### SUMMARY

A recording medium records a virtual machine control program. The virtual machine control program is a program for implementing a virtual machine monitor in a virtual machine system that includes a plurality of physical CPUs, a plurality of virtual machines that are programs each operating on the plurality of physical CPUs, and the virtual machine monitor for controlling the plurality of virtual machines. The virtual machine control program causes a computer that is the virtual machine system to execute the steps of: setting each of the plurality of physical CPUs as a physical CPU for first process or a physical CPU for second process; setting a first CPU time and a second CPU time to different values, the first CPU time being a period of time during which each of the plurality of virtual machines retains a control right of a physical CPU for the first process, the second CPU time being a period of time during which each of the plurality of virtual machines retains a control right of a physical CPU for the second process; and when the control right of a physical CPU for the first process is assigned to any one of the plurality of virtual machines, setting the first CPU time for the virtual machine and assigning the control right to the virtual machine, and, when the control right of a physical CPU for the second process is assigned to any one of the plurality of virtual machines, setting the second CPU time for the virtual machine and assigning the control right to the virtual machine.

The object and advantages of the invention will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 is a diagram illustrating an example of a configuration of a virtual machine system;

FIG. 2 is a diagram illustrating an example of a configuration of a virtual machine monitor and a piece of hardware;

FIG. 3 is a diagram illustrating a data structure of scheduling data;

FIGS. 4A and 4B are diagrams illustrating examples of scheduling data;

FIG. 5 is a diagram describing the operations of physical CPUs included in a virtual machine system;

FIG. 6 is a flowchart illustrating a control process in the virtual machine system illustrated in FIG. 1; and

FIG. 7 is a diagram describing the control of a virtual machine system studied by an inventor of the present invention.

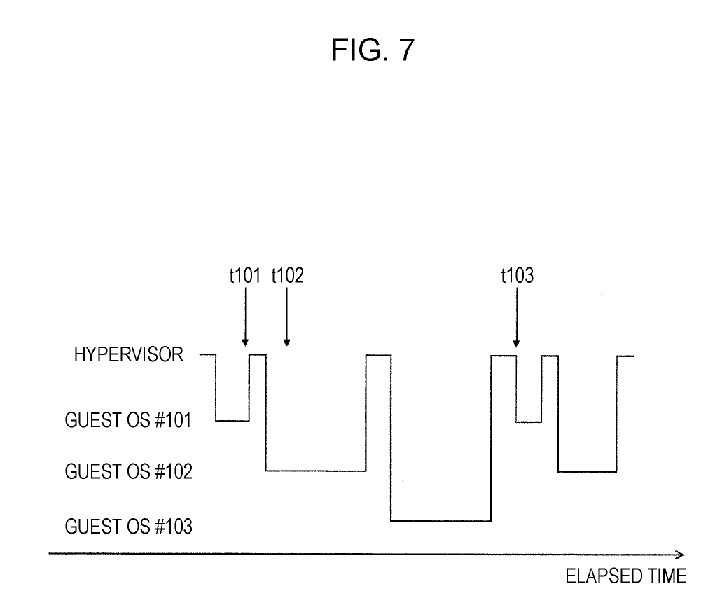

### DESCRIPTION OF EMBODIMENTS

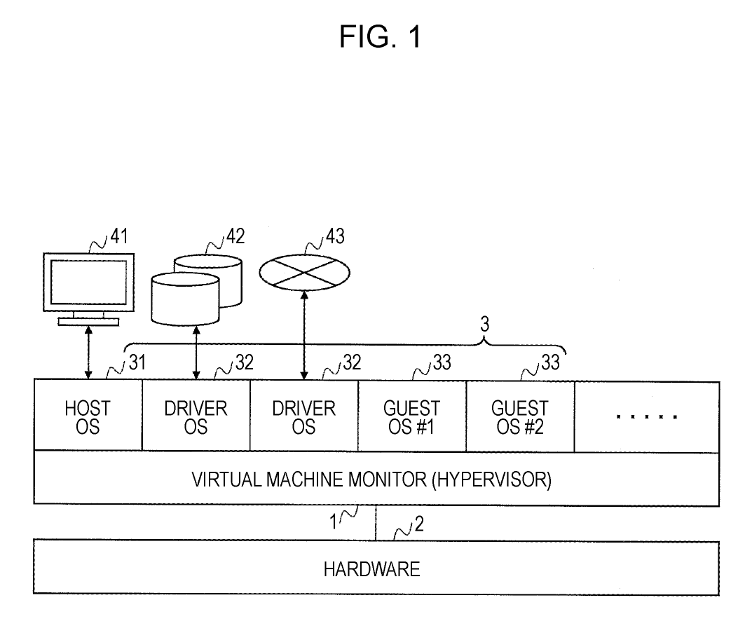

FIG. 1 is a diagram illustrating an example of a configuration of a virtual machine system. A virtual machine system includes a virtual machine monitor (VMM) (or a hypervisor) 1, a piece of hardware 2, and a plurality of virtual machines (VMs) 3. The virtual machine monitor 1 and the virtual machines 3 operate on the hardware 2.

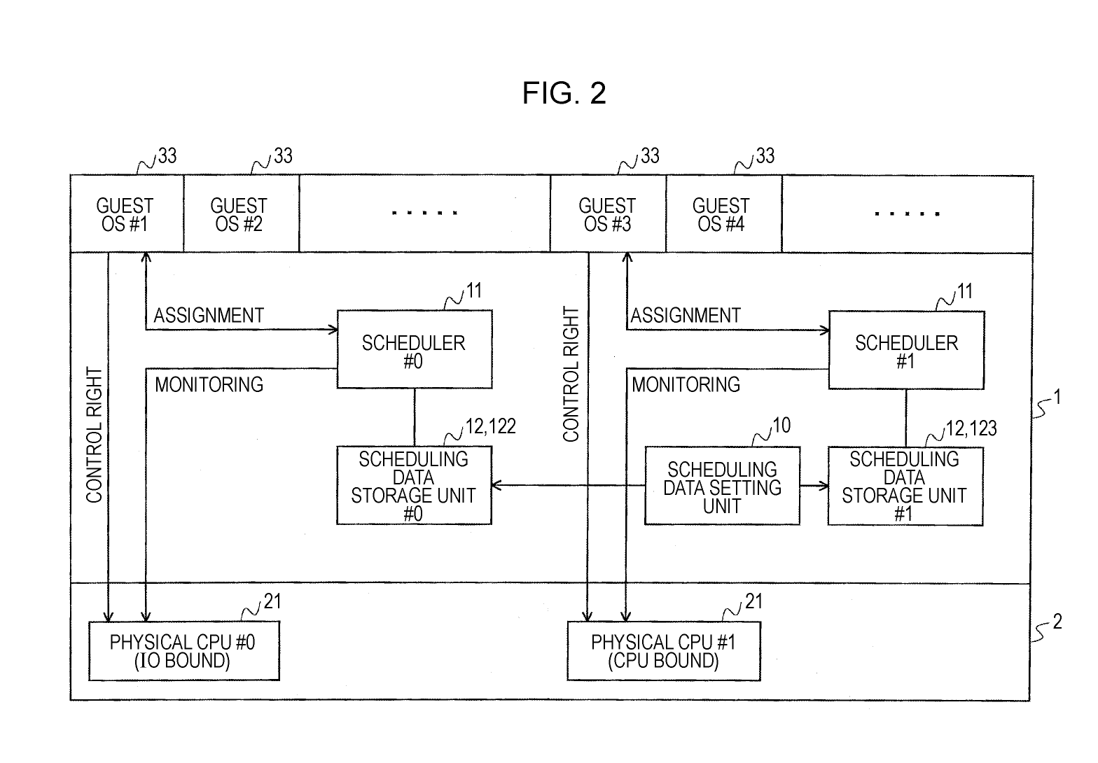

The virtual machine system includes the virtual machines 3, that is, a host OS (operating system, that is, a control program) 31, driver OSs 32, and guest OSs 33. Each of the OSs 31 to 33 acquires the control right of one of physical CPUs 21 (see, FIG. 2) included in the hardware 2 and is executed on the physical CPU 21, whereby corresponding one of the virtual machines 3 is implemented. The virtual machine monitor 1 is similarly implemented.

The virtual machine monitor 1 performs overall control of the virtual machine system. That is, the virtual machine monitor 1 performs dispatching for the virtual machines 3, that is, the OSs 31 to 33 (the assignment of the control right of the physical CPU 21 to the OSs 31 to 33), the emulation of a privileged instruction executed by each of the OSs 31 to 33, and the control of the hardware 2, for example, the physical CPU 21 included in the hardware 2.

The host OS 31 operates as a virtual machine (domain), and performs overall management of the virtual machine system. At the time of booting the virtual machine system, the host OS 31 is started, and controls the driver OSs 32 and the guest OSs 33 (performs overall control including the start and stop of the driver OSs 32 and the guest OSs 33). At the same time, the host OS 31 can operate as the driver OS 32. The host OS 31 includes a console 41 such as a display device.

The driver OSs 32 are OSs for controlling physical (or real) input/output (I/O) devices 42 and 43. The physical I/O devices 42 and 43 are different types of devices. For example, the physical I/O device 42 may be a magnetic disk device, and the physical I/O device 43 may be a network. Driver OSs 32 are provided for each of the physical I/O devices 42 and 43. Control of the physical I/O devices 42 and 43 is performed by the driver OSs 32. Each of the driver OSs 32 may operate on the host OS 31 or one of the guest OSs 33. If each of the driver OSs 32 operates on one of the guest OSs 33, the guest OS 33 becomes the apparent driver OS 32.

The guest OSs 33 are OSs that do not include the physical I/O devices 42 and 43. Each of the guest OSs 33 may be considered a normal OS. For example, an application program may operate on one of the guest OSs 33. Each of the guest OSs 33 requests one of the driver OSs 32 to execute an I/O command, whereby the I/O command can be executed.

FIG. 2 is a diagram illustrating an example of a configuration of the virtual machine monitor 1 and the hardware 2. FIG. 2 illustrates only the guest OSs 33 (#1 to #4) as the virtual machines 3. Although a case in which the virtual machines 3 are the guest OSs 33 will be described below, the virtual machines 3 may be the host OS 31 and/or the driver OSs 32.

The virtual machine monitor 1 includes a scheduling data setting unit (hereinafter referred to as a “setting unit”) 10, a plurality of schedulers 11, and a plurality of scheduling data storage units (hereinafter referred to as “storage units”) 12. The schedulers 11 are individually disposed for the physical CPUs 21. Each of the schedulers 11 includes a storage unit 12 for storing scheduling data. Accordingly, the storage unit 12 and scheduling data are also prepared for each of the physical CPUs 21.

The hardware 2 includes the physical (or real) CPUs 21. In FIG. 2, for the sake of simplification of the drawing, only two CPUs are illustrated. In order to distinguish between the physical CPUs 21, for example, the physical CPUs 21 are represented as physical CPUs #0 and #1. In order to distinguish between the schedulers 11 or the storage units 12, the same representation method is used.

Referring to FIG. 2, for example, the physical CPU #0 is an I/O bound CPU, and the physical CPU #1 is a CPU bound CPU. An I/O bound job is a program for frequently performing input/output (I/O) processes via a disk device or a network in a database system (a program for a setting process using an I/O device as a dominant process). The shorter the time it takes to complete the I/O process, the faster the response of the I/O bound job. A CPU bound job is a program for performing a computation such as a scientific computation while intensively using a CPU (physical CPU) (a program for a setting process using a physical CPU as a dominant process). The larger the amount of CPU time allotted to a CPU bound job, the faster the response of the CPU bound job.

As will be described later, the attributes of the CPU bound physical CPU 21 and the I/O bound physical CPU 21 are not fixed, and the numbers of the CPU bound physical CPUs 21 and the I/O bound physical CPUs 21 are not necessarily the same.

As described previously, the virtual machine monitor 1 and the guest OSs 33 (that is, the virtual machines 3) operate on the physical CPUs 21. In the virtual machine system, one of the schedulers 11 assigns the control right of a corresponding physical CPU 21 to one of the guest OSs 33, and the other one of the schedulers 11 assigns the control right of a corresponding physical CPU 21 to one of the guest OSs 33, whereby virtualization of the physical CPUs 21 is achieved. After one of the guest OSs 33 has received the control right of one of the physical CPUs 21 and operated, the control right of the physical CPU 21 is transferred back to the virtual machine monitor 1 without fail.

In this virtual machine system, the I/O bound guest OS 33 and the CPU bound guest OS 33 operate on physical CPUs 21 that are different physical CPUs. Furthermore, in this virtual machine system, the period of time (CPU time) during which each of the guest OSs 33 retains the control right of one of the physical CPUs 21 is different from the period of time (CPU time) during which each of the guest OSs 33 retains the control right of the other one of the physical CPUs 21. As a result, appropriate control can be performed for the I/O bound guest OS 33 or the CPU bound guest OS 33 in accordance with characteristics of a corresponding program.

One of the schedulers 11 assigns (dispatches) the control right of one of the physical CPUs 21 to one of the guest OSs 33 on the basis of scheduling data 122 stored in the storage unit 12, and the other one of the schedulers 11 assigns (dispatches) the control right of the other one of the physical CPUs 21 to one of the guest OSs 33 on the basis of scheduling data 123 stored in the storage unit 12. The scheduling data 122 and the scheduling data 123 are set by the setting unit 10 prior to the assignment of the physical CPUs 21 to the guest OSs 33.

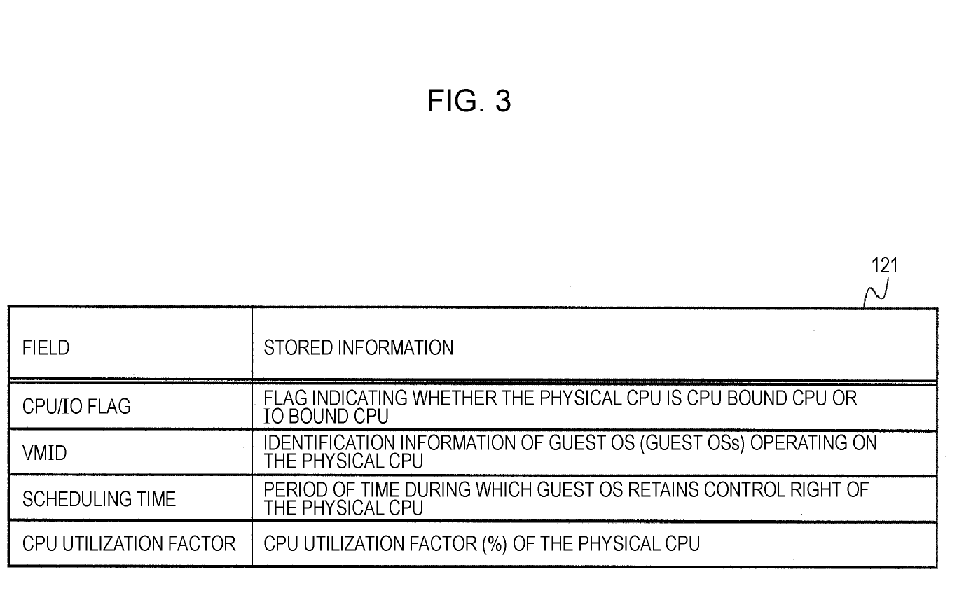

FIG. 3 is a diagram illustrating a data structure 121 of each of the scheduling data 122 and the scheduling data 123. The scheduling data (that is, the data structure 121) includes fields for storing a CPU/I/O flag, a VMID, a scheduling time, and a CPU utilization factor. In FIG. 3, although only the guest OSs 33 are illustrated as the virtual machines 3, another type of virtual machine 3 may be used.

The CPU/I/O flag indicates process setting information, that is, indicates whether the physical CPU 21 is a CPU bound or an I/O bound CPU. The VMID is identification (ID) information of the guest OS 33 (that is, a virtual machine (VM)), and is set in advance by the virtual machine system. The VMID indicates one of the guest OSs 33 which is operating on the physical CPU 21. If a plurality of guest OSs, that is, the guest OSs 33, are operating on the physical CPU 21, the IDs of the guest OSs 33 are stored. The scheduling time is information about an allotted time, that is, the period of time during which the guest OS 33 retains the control right of the physical CPU 21. The CPU utilization factor is the utilization factor (%) of the physical CPU 21, that is, the ratio (%) of the period of time during which the physical CPU 21 is used to the period of time during which the virtual machine system operates.

The setting unit 10 is a process setting unit for setting a process or an application of each of the physical CPUs 21. That is, the setting unit 10 sets each of the physical CPUs 21 as a CPU for an I/O bound job process (first process) or a CPU for a CPU bound job process (second process). For the setting process, the setting unit 10 sets the CPU/I/O flag included in the scheduling data. Accordingly, the process of the physical CPU 21 is determined using the storage unit 12. The CPU/I/O flag includes a CPU flag and an I/O flag. If the physical CPU 21 is CPU bound CPU, the value of the CPU flag is set to “1”. If the physical CPU 21 is an I/O bound CPU, the value of the I/O flag is set to “1”.

The setting unit 10 sets the IDs of each of the guest OSs 33. That is, upon receiving assignment requests from the guest OSs 33, the setting unit 10 registers the IDs of the guest OSs 33 in the VMID field included in scheduling data corresponding to the physical CPU 21 that is to be assigned to the guest OSs 33 in the order of assignment requests received. As a result, the physical CPU 21 is assigned to each of the guest OSs 33. Accordingly, each of the guest OSs 33 is registered in either the scheduling data 122 or the scheduling data 123. The registration of VMIDs may be performed by the scheduler 11.

The setting unit 10 is also a CPU time setting unit for setting a CPU time. The CPU time is a period of time during which each of the guest OSs 33 retains the control right of the physical CPU 21. At that time, a first CPU time and a second CPU time are set so that they are different from each other. The first CPU time is a period of time during which each of the guest OSs 33 retains the control right of the physical CPU 21 (#0) for the I/O bound job process (the first process), and the second CPU time is a period of time during which each of the guest OSs 33 retains the control right of the physical CPU 21 (#1) for the CPU bound job process (the second process).

In order to set a CPU time, the setting unit 10 sets a scheduling time included in the scheduling data. At that time, in the storage unit 12, the second CPU time is set so that it becomes longer than the first CPU time. For example, the first CPU time is set to 1 millisecond, and the second CPU time is set to 50 milliseconds. Accordingly, the scheduling time of the I/O bound physical CPU 21 becomes shorter than the scheduling time of the CPU bound physical CPU 21.

The scheduler 11 assigns units for assigning the control right of the physical CPU 21 to one of the guest OSs 33. At that time, the scheduler 11 assigns the control right of the physical CPU 21 to one of the guest OSs 33 based on the scheduling data stored in the storage unit 12.

That is, if the scheduler 11 assigns the control right of the physical CPU 21 for an I/O bound job process (I/O bound) to one of the guest OSs 33, the scheduler 11 sets the allocation time to the first CPU time and assigns the control right of the physical CPU 21 to one of the guest OSs 33. If the scheduler 11 assigns the control right of the physical CPU 21 for a CPU bound job process (CPU bound) to one of the guest OSs 33, the scheduler 11 sets the allocation time to the second CPU time and assigns the control right of the physical CPU 21 to one of the guest OSs 33.

After assigning the control right of the physical CPU 21 to one of the guest OSs 33, the scheduler 11 monitors the guest OS 33 to which the control right of the physical CPU 21 has been assigned. That is, the scheduler 11 periodically determines whether the guest OS 33 is in an idle state or not. As is well known, by determining the change in the contents of a register of the physical CPU 21 assigned to the guest OS 33, it can be determined whether the guest OS 33 is in the idle state or not.

The I/O bound guest OS 33 is prone to be in the idle state, because the guest OS 33 is required to wait for completion of the I/O process. That is, the guest OS 33 being in the idle state can be considered to be an I/O bound guest OS. Accordingly, based on a result of the idle state determination, it can be determined whether the guest OS 33 is an I/O bound guest OS or a CPU bound guest OS.

If it is determined that the guest OS 33 is in the idle state, the control right of the I/O bound physical CPU 21 is to be assigned to the guest OS 33 a next time. That is, the guest OS 33 is registered in the scheduling data 122. If it is determined that the guest OS 33 is not in the idle state, the guest OS 33 is registered in the scheduling data 123. Consequently, the physical CPU 21 can be appropriately determined for each of the guest OSs 33.

In this example, at the time of detection of the idle state of the guest OS 33, a process for transferring the control right of the physical CPU 21 from the guest OS 33 back to the virtual machine monitor 1 is not performed. The reason for this is that the I/O bound guest OS 33 is usually executed on the I/O bound physical CPU 21 (after the state of the guest OS 33 has been changed from the idle state to the normal state). Accordingly, after the state of the guest OS 33 has been changed to the idle state, even if the virtual machine monitor 1 waits until the scheduling time has elapsed, only a small amount of time is wasted. On the other hand, the process for transferring the control right of the physical CPU 21 from the guest OS 33 back to the virtual machine monitor 1 becomes a significant burden. Therefore, the process is not performed.

The detection of the idle state is performed at time intervals set in advance for all the physical CPUs 21 each of which is assigned to one of the guest OSs 33, the host OS 31, and the driver OSs 32. The time intervals are empirically determined. For example, time intervals much shorter than the first CPU time may be set.

The setting unit 10 changes the numbers of the physical CPUs for the first process and the physical CPUs for the second process in accordance with the utilization factors of the physical CPUs for the first process and the physical CPUs for the second process. Accordingly, the I/O bound physical CPU #0 for is set as a CPU bound physical CPU when desired. For example, in the scheduling data 122 of the physical CPU #0, the value of the CPU flag is changed to 1 and the value of the I/O flag is changed to 0. In a case in which the CPU bound physical CPU #1 is set as an I/O bound physical CPU, the same process is performed. The CPU utilization factor is updated at specific time intervals. The time intervals are empirically determined. For example, the time intervals may be as long as the first CPU time.

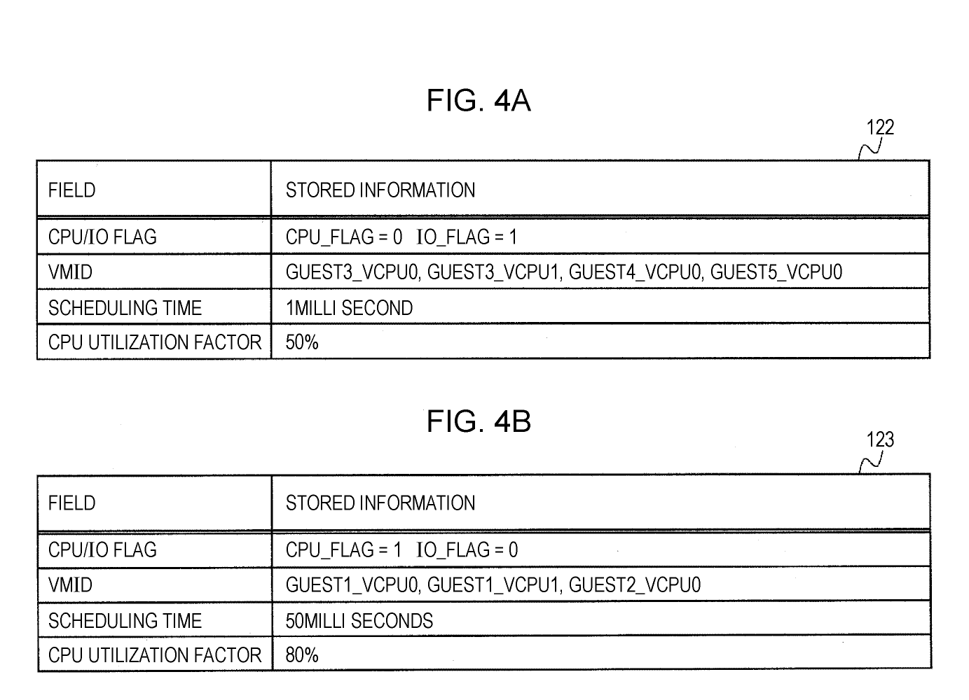

FIG. 4A is a diagram illustrating an example of the scheduling data 122 of the I/O bound physical CPU 21 (#0). The setting unit 10 stores the scheduling data 122 in the storage unit 12 (#0), thereby setting the physical CPU 21 (#0) as an I/O bound CPU.

In the CPU/I/O flag field, the value of the CPU flag is set to 0 and the value of the I/O flag is set to 1. Accordingly, the physical CPU 21 is an I/O bound CPU. In the VMID field, for example, four VMIDs are stored. Accordingly, four guest OSs, for example, the guest OSs 33, operate on the physical CPU 21, and the control right of the physical CPU 21 is sequentially assigned to the guest OSs 33 in the order illustrated in the drawing. Since the physical CPU 21 is an I/O bound CPU, for example, a short scheduling time of 1 millisecond is set. In the CPU utilization factor field, the fact that the utilization factor of the physical CPU 21 is 50% is indicated.

For example, a VMID “guest3_vcpu0” represents a guest OS “guest3” included in a virtual machine “vcpu0”. The guest OS “guest3” represents a guest OS #3 that is one of the guest OSs 33. The virtual machine “vcpu0” represents a virtual machine (virtual CPU) #0. That is, the guest OS #3 operates on the physical CPU #0, thereby forming the virtual machine #0.

FIG. 4B is a diagram illustrating an example of the scheduling data 123 of the CPU bound physical CPU 21 (#1). The setting unit 10 stores the scheduling data 123 in the storage unit 12 (#1), thereby setting the physical CPU 21 (#1) as a CPU bound CPU.

In the CPU/I/O flag field, the value of the CPU flag is set to 1 and the value of the I/O flag is set to 0. Accordingly, the physical CPU 21 is a CPU bound CPU. In the VMID field, three VMIDs are stored. Accordingly, three guest OSs, for example, the guest OSs 33, operate on the physical CPU 21, and the control right of the physical CPU 21 is sequentially assigned to the guest OSs 33 in the order illustrated in the drawing. Since the physical CPU 21 is a CPU bound CPU, for example, a long scheduling time of 50 milliseconds is set. In the CPU utilization factor field, the fact that the utilization factor of the physical CPU 21 is 80% is indicated.

As is apparent from FIGS. 4A and 4B, the physical CPU #0 is managed using the I/O bound scheduling data 122, and the physical CPU #1 is managed using the CPU bound scheduling data 123. Accordingly, the physical CPU #0 is an I/O bound CPU and the physical CPU #1 is a CPU bound CPU. Thus, an I/O bound CPU and a CPU bound CPU are different physical CPUs.

The period of time (scheduling time) allotted to the I/O bound physical CPU 21 (#0) and the period of time (scheduling time) allotted to the CPU bound physical CPU 21 (#1) are set so that they are different from each other, that is, the period of time allotted to the physical CPU 21 (#1) becomes longer than that allotted to the physical CPU 21 (#0).

For example, a scheduling time in a virtual machine system is generally 20 milliseconds. In this case, the virtual machine monitor 1 operates 50 times per second. Since the scheduling time of the I/O bound physical CPU #0 illustrated in FIG. 4A is 1 millisecond, an I/O response of 4 milliseconds can be achieved in a case in which the four guest OSs 33 operate. Accordingly, a twentyfold(=(20 milliseconds×4 guest OSs)/4 milliseconds) improvement in the I/O response can be achieved. In FIG. 4B, since the scheduling time of the CPU bound physical CPU #1 is 50 milliseconds, the virtual machine monitor 1 operates 20 times per second. Accordingly, the overhead of the virtual machine monitor 1 can be reduced by 60(=(20 times/50 times)×100)percent.

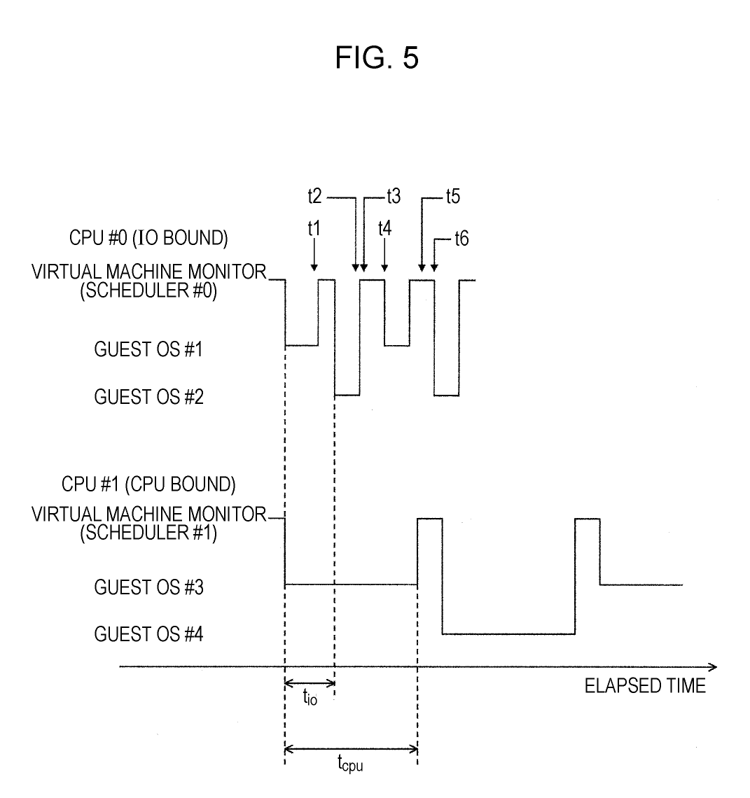

FIG. 5 is a diagram describing the operations of the physical CPUs 21 in the virtual machine system. In this example, there are the two physical CPUs 21 (#0 and #1) and the four guest OSs 33 (#1 to #4). The control rights of the physical CPUs 21 are assigned on the basis of the scheduling data 122 and the scheduling data 123. The physical CPU #0 is an I/O bound CPU and the physical CPU #1 is a CPU bound CPU. The guest OSs #1 and #2 are I/O bound guest OSs, and the guest OSs #3 and #4 are CPU bound guest OSs.

A time tᵢₒ is a short period of time of 1 millisecond, and a time t_{cpu} is a long period of time of 50 milliseconds. In FIG. 5, for the sake of simplification of the drawing, the time axis is not to scale.

The assignment of the I/O bound physical CPU #0 is performed as follows. First, the scheduler #0 assigns the control right of the physical CPU #0 to the guest OS #1 on the basis of the scheduling data 122. At a time t1, the guest OS #1 performs an I/O interrupt and becomes idle. Since the guest OS #1 is an I/O bound guest OS, the period of time tᵢₒ (CPU allocation time) during which the guest OS #1 retains the control right of the physical CPU #0 is a short period of time of 1 millisecond. Accordingly, shortly after the state of the guest OS #1 has been changed to the idle state, the control right of the physical CPU #0 is transferred back to the scheduler #0 (that is, the virtual machine monitor 1).

Subsequently, the scheduler #0 assigns the control right of the physical CPU #0 to the guest OS #2. At a time t2, the guest OS #2 performs an I/O interrupt and becomes idle. Shortly after the state of the guest OS #2 has been changed to the idle state, the control right of the physical CPU #0 is transferred back to the scheduler #0.

The I/O interrupt performed by the guest OS #1 is completed at a time t3. The scheduler #0 reassigns the control right of the physical CPU #0 to the guest OS #1. At a time t4, the guest OS #1 receives the control right of the physical CPU #0 and notifies the scheduler #0 of the completion of the I/O interrupt. Accordingly, the guest OS #1 can perform an I/O completion interrupt without waiting a long time after performing the I/O interrupt. Shortly afterward, the control right of the physical CPU #0 is transferred back to the scheduler #0.

At a time t5, the I/O interrupt performed by the guest OS #2 is completed. The scheduler #0 reassigns the control right of the physical CPU #0 to the guest OS #2. At a time t6, the guest OS #2 can receive the control right of the physical CPU #0 and notify the scheduler #0 of the completion of the I/O interrupt without waiting a long time after performing the I/O interrupt. Shortly afterward, the control right of the physical CPU #0 is transferred back to the scheduler #0.

Thus, in the I/O bound guest OSs 33 (#1 and #2), the I/O response can be improved (the period of time of an I/O response can be shortened). In particular, in the I/O bound guest OSs 33 (#1 and #2), the deterioration of the I/O response due to the influences of the CPU bound guest OSs 33 (#3 and #4) can be reduced if not prevented.

On the other hand, the assignment of the CPU bound physical CPU #1 is performed as follows. First, the scheduler #1 assigns the control right of the physical CPU #1 to the guest OS #3 on the basis of the scheduling data 123. The guest OS #3 performs process using the physical CPU #1 without being idle. At that time, since the period of time t_{cpu} allotted to the guest OS #3 is a long period of time of 50 milliseconds, the guest OS #3 can fully perform process using the physical CPU #1. Subsequently, the control right of the physical CPU #1 is transferred back to the scheduler #1.

Subsequently, the scheduler #1 assigns the control right of the physical CPU #1 to the guest OS #4. The guest OS #4 fully performs a process using the physical CPU #1 without being idle in the long period of time t_{cpu} of 50 milliseconds. Subsequently, the control right of the physical CPU #1 is transferred back to the scheduler #1.

Thus, on the CPU bound physical CPU 21 (#1), the guest OSs 33 (#1 and #2) for which a quick I/O response is required do not operate. Accordingly, the allocation time t_{cpu} allotted to each of the guest OSs 33 (#3 and #4) can be lengthened. As a result, the period of time during which each of the guest OSs 33 (#3 and #4) runs (operates) can be lengthened. Therefore, the cache hit rate in the physical CPU 21 (#1) can be improved, and the performance of the virtual machine system can be improved. Since the number of times the virtual machine monitor 1 operates may be reduced, the overhead may also be reduced.

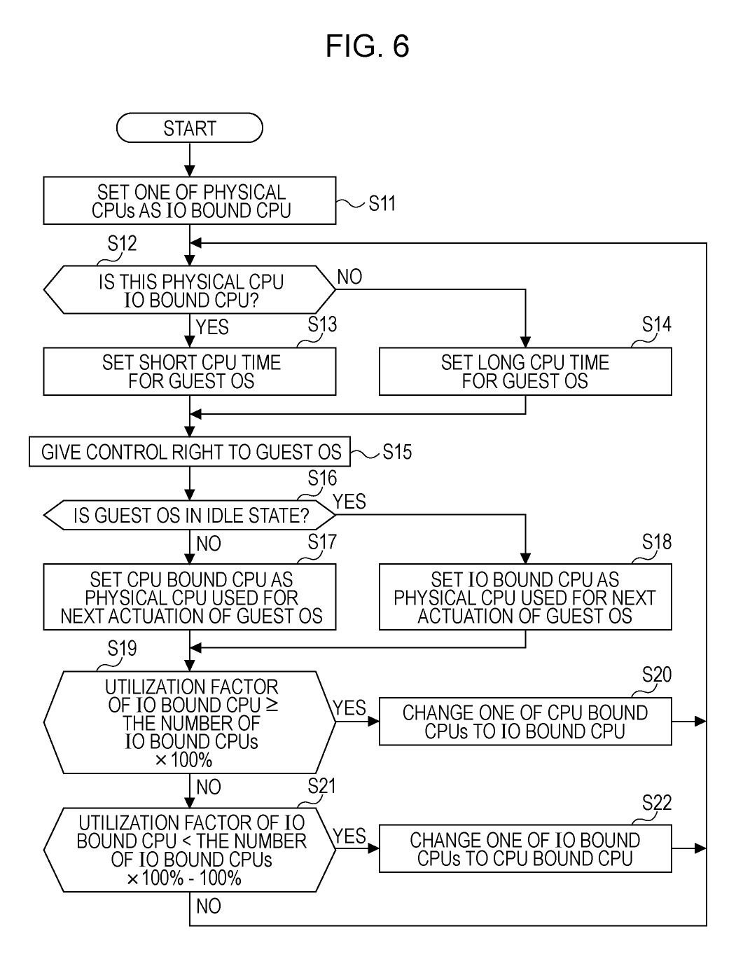

FIG. 6 is a flowchart illustrating a dispatching process of the physical CPUs 21 included in the virtual machine system illustrated in FIG. 1.

The setting unit 10 sets one of the physical CPUs 21 as an I/O bound CPU before the execution of a job is started (step S11). For example, in the storage unit 12, the value of the I/O flag is set to 1, the value of the CPU flag is set to 0, and the value of a scheduling time is set to 1 millisecond. At that time, for the other one of the physical CPUs 21, the value of 0 of the I/O flag and the value of 1 of the CPU flag are maintained, and the value of a scheduling time is set to 50 milliseconds. For all of the physical CPUs 21, no VMIDs are stored, and a CPU utilization factor is set to 0%.

Subsequently, one of the guest OSs 33 starts to execute a job and requests the virtual machine monitor 1 to assign the control right of the physical CPU 21 thereto. In response to this request, the scheduler 11 registers the guest OS 33 in the storage unit 12 corresponding to the physical CPU 21 whose control right is to be assigned to the guest OS 33, and determines whether the physical CPU 21 is an I/O bound CPU by referring to a CPU/I/O flag stored in the storage unit 12 (step S12). Accordingly, the period of time allotted to the guest OS 33 is determined in accordance with the attribute (process) of the physical CPU 21.

If the physical CPU 21 is an I/O bound CPU, the scheduler 11 sets a short period of time for a dispatching timer (not illustrated) included therein as a CPU time to be allotted to the guest OS 33 based on the scheduling time included in the scheduling data 122 (step S13). If the physical CPU 21 is not an I/O bound CPU (that is, the physical CPU 21 is a CPU bound CPU), the scheduler 11 sets a long period of time for the dispatching timer included therein as a CPU time to be allotted to the guest OS 33 based on the scheduling time included in the scheduling data 123 (step S14).

The scheduler 11 assigns the control right of the physical CPU 21 to the guest OS 33 (step S15). The scheduler 11 determines whether the guest OS 33 is in the idle state (step S16). As is well known, the control right of the physical CPU 21 is assigned to the guest OSs 33 by writing a lockword into a specific area in a memory (not illustrated) included in the guest OS 33.

If the guest OS 33 is not in the idle state, the setting unit 10 sets one of the physical CPUs 21 which is used to operate the guest OS 33 a next time (that is, one of the physical CPUs 21 which is to be assigned to the guest OS 33) as a CPU bound CPU (step S17). That is, based on a notification that the guest OS 33 is not in the idle state transmitted from the scheduler 11, the setting unit 10 registers the guest OS 33 in the scheduling data 123. If the guest OS 33 is in the idle state, the setting unit 10 sets one of the physical CPUs 21 which is used to operate the guest OS 33 a next time as an I/O bound CPU (step S18). That is, based on a notification that the guest OS 33 is in the idle state transmitted from the scheduler 11, the setting unit 10 registers the guest OS 33 in the scheduling data 122.

Subsequent to steps S17 and S18, the control right of the physical CPU 21 is transferred back to the scheduler 11 (the virtual machine monitor 1) after the period of time set for the dispatching timer has elapsed. As is well known, the control right of the physical CPU 21 is transferred back to the scheduler 11 by deleting the lockword written in the guest OS 33.

The setting unit 10 determines whether the utilization factor (%) of the I/O bound CPU is equal to or larger than the ratᵢₒ (occupancy ratio) (%) of the number of I/O bound CPUs to the total number of the physical CPUs 21 (step S19). That is, the setting unit 10 determines whether there is a shortage of I/O bound CPUs and whether the setting unit 10 needs to make up for the shortage of I/O bound CPUs.

If the utilization factor is equal to or larger than the occupancy ratio, the setting unit 10 determines that there is a shortage of I/O bound CPUs and changes one of the CPU bound physical CPUs 21 to an I/O bound CPU (step S20). That is, the setting unit 10 sets the value of the CPU flag to 0, the value of the I/O flag to 1, and the value of the scheduling time to 1 millisecond in the storage unit 12. Thus, one of the pieces of scheduling data 123 is set as the scheduling data 122. As a result, the physical CPU 21 is changed to an I/O bound CPU. Subsequently, the scheduler 11 repeatedly performs the process from step S12.

In the scheduling data 122 in which the value of the I/O flag is set to 1 in step S20, the guest OSs 33 registered in the VMID field are maintained. The reason for this is that the guest OSs 33 are not necessarily the CPU bound guest OSs and it is impractical to register the guest OSs 33 in another piece of scheduling data, that is, the scheduling data 123 (in step S21, the reregistration of the guest OSs 33 is not performed as in this case).

If the utilization factor is not equal to or larger than the occupancy ratio, the setting unit 10 determines whether the utilization factor (%) of the I/O bound CPU is smaller than a value obtained by subtracting 100 (%) from the I/O bound CPU occupancy ratᵢₒ (%) (step S21). If the utilization factor is smaller than the value, the setting unit 10 determines that there is no shortage of the I/O bound CPUs (that is, there is a shortage of the CPU bound CPUs) and changes one of the I/O bound physical CPUs 21 to a CPU bound CPU (step S22). That is, the setting unit 10 sets the scheduling data 122 as the scheduling data 123 in the storage unit 12. As a result, the physical CPU 21 is changes to a CPU bound CPU. Subsequently, the scheduler 11 repeatedly performs the process from step S12.

If the utilization factor is not smaller than the value in step S21, the setting unit 10 determines that there is no shortage of the I/O bound CPUs or CPU bound CPUs (the numbers of the I/O bound CPUs and the CPU bound CPUs are appropriate). Subsequently, the scheduler 11 repeatedly performs the process from step S12.

In step S11, the number of the I/O bound physical CPUs 21 is one. However, by repeatedly performing the process from step S12 to step S22, all of the physical CPUs 21 are individually set as an I/O bound CPU or a CPU bound CPU, and the number of the I/O bound physical CPUs 21 is increased or reduced, that is, improved.

In step S15, it is not certain whether the control right of the physical CPU bound CPU 21 is assigned to the CPU bound guest OS 33. However, by repeatedly performing the process from step S12 to step S22, the number of CPU bound physical CPUs 21 is improved. By performing the process in step S17 or step S18, for example, the control right of the CPU bound physical CPU 21 can be assigned to the CPU bound guest OS 33 a next time. As a result, the CPU bound guest OS 33 can be effectively assigned to the CPU bound physical CPU 21. As in this case, the I/O bound guest OS 33 can be effectively assigned to the I/O bound physical CPU 21.

Since the attributes (CPU bound or I/O bound) of the physical CPUs 21 are not fixed, an operator is not required to manage the attributes. Since the virtual machine monitor 1 is not required to detect an I/O completion interrupt waiting state, an operator is not required to customize the guest OSs 33.

Although embodiments of the present invention have been described, the present invention is not limited to the above-described embodiments.

For example, in only the physical CPU 21 on which the I/O bound guest OS 33 operates, a physical interrupt (in particular, the I/O interrupt) may be received. That is, in the physical CPU 21 on which the CPU bound guest OS 33 operates, the I/O interrupt may not be performed. In this case, since the CPU bound physical CPU 21 does not perform the I/O interrupt, the overhead of the virtual machine monitor 1 can be reduced.

What is claimed is:

1. A recording medium recording a virtual machine control program for implementing a virtual machine monitor in a virtual machine system that includes a plurality of physical CPUs, a plurality of virtual machines that are programs each operating on the plurality of physical CPUs, and the virtual machine monitor for controlling the plurality of virtual machines, the virtual machine control program causing a computer that is the virtual machine system to execute the steps of:
setting each of the plurality of physical CPUs as a physical CPU for first process or a physical CPU for second process;
setting a first CPU time and a second CPU time to different values, the first CPU time being a period of time during which each of the plurality of virtual machines retains a control right of a physical CPU for the first process, the second CPU time being a period of time during which each of the plurality of virtual machines retains a control right of a physical CPU for the second process; and
when the control right of a physical CPU for the first process is assigned to any one of the plurality of virtual machines, setting the first CPU time for the virtual machine and assigning the control right to the virtual machine, and, when the control right of a physical CPU for the second process is assigned to any one of the plurality of virtual machines, setting the second CPU time for the virtual machine and assigning the control right to the virtual machine.

2. The recording medium recording a virtual machine control program according to claim 1,
wherein the first process is an I/O bound job process, and the second process is a CPU bound job process, and
wherein the second CPU time is longer than the first CPU time.

3. The recording medium recording a virtual machine control program according to claim 1, wherein the virtual machine control program further causes the computer to execute the step of changing the numbers of physical CPUs for the first process and physical CPUs for the second process in accordance with the utilization factors of physical CPUs for the first process and physical CPUs for the second process.

4. A virtual machine system including a plurality of physical CPUs, a plurality of virtual machines that are programs each operating on the plurality of physical CPUs, and a virtual machine monitor for controlling the plurality of virtual machines, the virtual machine monitor comprising:
process setting units for setting each of the plurality of physical CPUs as a physical CPU for first process or a physical CPU for second process;
CPU time setting units for setting a first CPU time and a second CPU time to different values, the first CPU time being a period of time during which each of the plurality of virtual machines retains a control right of a physical CPU for the first process, the second CPU time being a period of time during which each of the plurality of virtual machines retains a control right of a physical CPU for the second process; and
assigning units for, when the control right of a physical CPU for the first process is assigned to any one of the plurality of virtual machines, setting the first CPU time for the virtual machine and assigning the control right to the virtual machine, and, when the control right of a physical CPU for the second process is assigned to any one of the plurality of virtual machines, setting the second CPU time for the virtual machine and assigning the control right to the virtual machine.
